(19) United States
(12) Patent Application Publication
(10) Pub. No.: US 2006/0072556 A1
(43) Pub. Date: Apr. 6, 2006

(54) System and method for prognosticator performance verification

(76) Inventor: David L. Garrett, Fruit Heights, UT (US)

Correspondence Address: John R. Thompson;STOEL RIVES LLP, One Utah Center, 201 South Main Street, Suite 1100, Salt Lake City, UT, 84111, US

(21) Appl. No.: 11/244,964

(22) Filed: Oct. 6, 2005

Related U.S. Application Data
(60) Provisional application No. 60/616,473, filed on Oct. 6, 2004.

(51) Int. Cl. H04L 12/66

(52) U.S. Cl. 370/352

(57) ABSTRACT

A system and method for providing prognosticator performance verification to a subscriber includes a server, which receives allocation change signals from a plurality of prognosticators, and each allocation change is associated with an asset class. The allocation changes are processed by the server by attaching a time-date stamp on each and storing the allocation changes in a database in electronic communication with the server. The server, in response to subscriber request, executes a report module resident in its memory. The report module accesses the allocation changes in the database, and with the allocation changes, generates a allocation change performance report, called a medallion report. The medallion report displays, in chart form, a plurality of signal asset classes using a plurality of chart parameters, the defaults for which are set by a prognosticator. The report module may verify the authenticity of the time-date stamps. Finally, the server sends the medallion report to the subscriber. The medallion report is modifiable through changing chart parameters or asset classes, thus providing a valuable tool for accurately analyzing prognosticator performance.

### RELATED APPLICATIONS

The present application is related to and claims priority from U.S. Provisional Application No. 60/616,473 entitled “System and Method for Prognosticator Performance Verification” and filed on Oct. 6, 2004, which is hereby incorporated by reference.

### TECHNICAL FIELD

The present disclosure relates to real-time financial allocation changes in an on-line environment and verification of prognosticator past performance.

### BRIEF DESCRIPTION OF THE DRAWINGS

Non-limiting and non-exhaustive embodiments of the disclosure are described.

FIG. 1 is a block diagram illustrating a system of the disclosure.

FIG. 2 is a flow diagram of an embodiment of the disclosed method.

FIG. 3 is one embodiment of a graphical representation of a prognosticator performance report with a list of selectable parameters, showing trade markers.

FIG. 4 is FIG. 3 with allocation changes combined and still compared against a market index.

FIG. 5 is one embodiment of a graphical representation of a performance ranking, comparing multiple prognosticators' performance in timing a specific asset.

FIG. 6 is one embodiment of a graphical representation displaying specific details of a prognosticator, chosen from a list of prognosticators.

FIG. 7 is one embodiment of a graphical representation of historical trades of a prognosticator from the date allocation changes began for the prognosticator.

### DETAILED DESCRIPTION

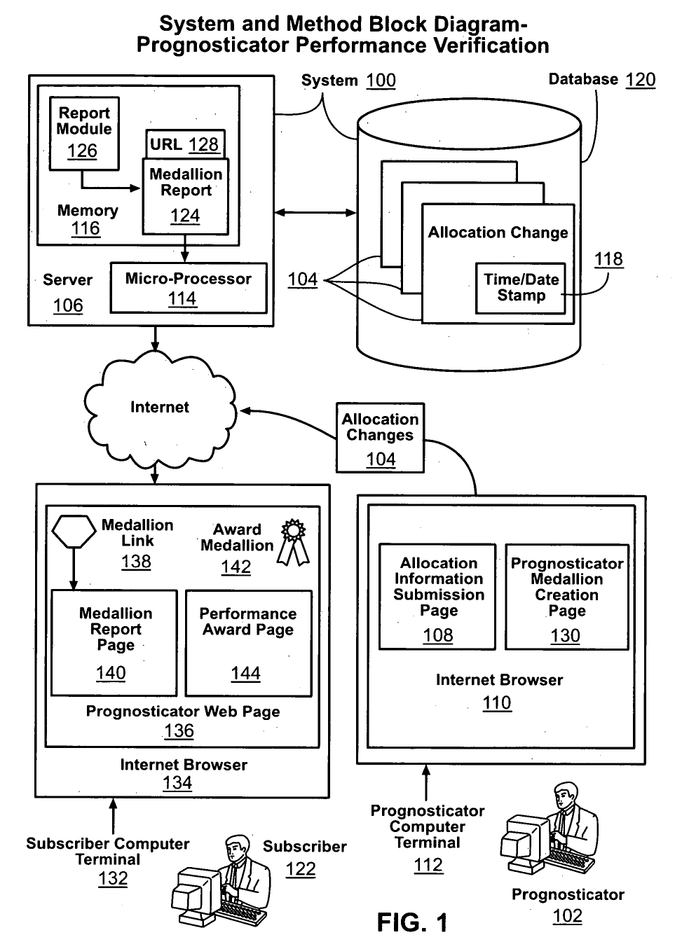

Preferred embodiments will be best understood by reference to the drawings, wherein like parts are designated by like numerals and terminology throughout. It will be readily understood that the components of various embodiments, as generally described and illustrated in the Figures herein, could be arranged and designed in a wide variety of different configurations. Thus, the following more detailed description of the embodiments of the apparatus, system, and method of the disclosure, as represented in FIGS. 1-7, is not intended to limit the scope of the disclosure, as claimed, but are merely representative of various preferred embodiments.

The disclosure provides for a system or method for third party verification of performance of market prognosticators and money managers. Such verification ensures that allocation changes used to track performance were actually sent and used in real-time by subscribers in making investment decisions. Thus, any on-line subscriber may accurately track the performance of market prognosticators or money managers.

A market prognosticator (or money manager), as used herein, may be a financial market expert who, based on his/her own market analysis over time, provides allocation changes to subscribers. Allocation change signals indicate whether or not to buy or sell specific equities at given moments in time, and are usually sent as an electronic submission to subscribers. Prognosticators are often also called “timers.” Allocation changes are thus categorical indications or “signals” to subscribers whether or not an equity should be bought or sold at the time the suggested change is provided. Thus, an allocation change signal requires immediate action on the part of a subscriber to timely profit from the signal. Throughout the disclosure, an “allocation change” will be synonymous with “signal” or “signal asset class”.

A subscriber is a person who pays money for a subscription (or entitlement) to receive a prognosticator's (or a money manager's) allocation change signals. A subscription to receive allocation changes does not provide allocation changes at predetermined internals. Allocation changes are delivered at unknown times and at unknown frequencies.

The disclosure also refers often to the performance of a prognosticator. This refers to the prognosticator's ability to accurately predict the rise and fall of specific equities, asset classes, or indexes by giving suggestions to sell or buy at the proper times. Thus, historical data of allocation changes sent in real-time is valuable to determine a prognosticator's trade performance. Time-date stamps that accompany or are attached to allocation changes may be used to authenticate the real-time nature (and accuracy) of the allocation changes used, thus providing “verification” of allocation change performance.

Referring to FIG. 1, a block diagram illustrates system 100 for verifying prognosticator performance. A prognosticator 102 sends allocation changes 104 to server 106 by use of an allocation information submissions page 108 in Internet browser 110 of the prognosticator's computer terminal 112. One skilled in the art will appreciate that sending allocation changes 104 may also be done via e-mail or telnet submission. Server 106 having microprocessor 114 and memory 116 may then process allocation changes 104 by ensuring they contain a time-date stamp 118 before sending them to be stored in database 120. Thus, database 120 includes allocation changes 104 that are received from prognosticator 102 just as a subscriber 122 would receive allocation changes 104 in accordance with a subscription.

A prognosticator 102 may create a customized medallion report 124 by initiating a report module 126 that is resident in or in electrical communication with a server 106. Medallion report 124 may have affiliated with it a uniform resource locator (URL) address 128 of server 106, which may also act as a web server host.

Access to customization of report 124 is through Internet browser's 110's prognosticator medallion creation page 130. Customization also requires server 106 to store, in either database 120 or memory 116, further relevant information specific to prognosticator 102 for filling fields of various reports, including medallion report 124. Medallion report 124 is so named as it is indicative of a prognosticator 102's performance in generating allocation changes and serves as an electronic acknowledgement of the authenticity of allocation changes 104. Subscription to a prognosticator 102 enables access to the allocation change 104 signals. A market manager, or any other user, may generate a customized medallion report 124 to reflect a prognosticator's performance. A user or prospective user of these reports may also be referred to jointly as a “subscriber” 122. A medallion report 124 may delay current information to protect real-time viewing by subscribers who have not subscribed to a prognosticator.

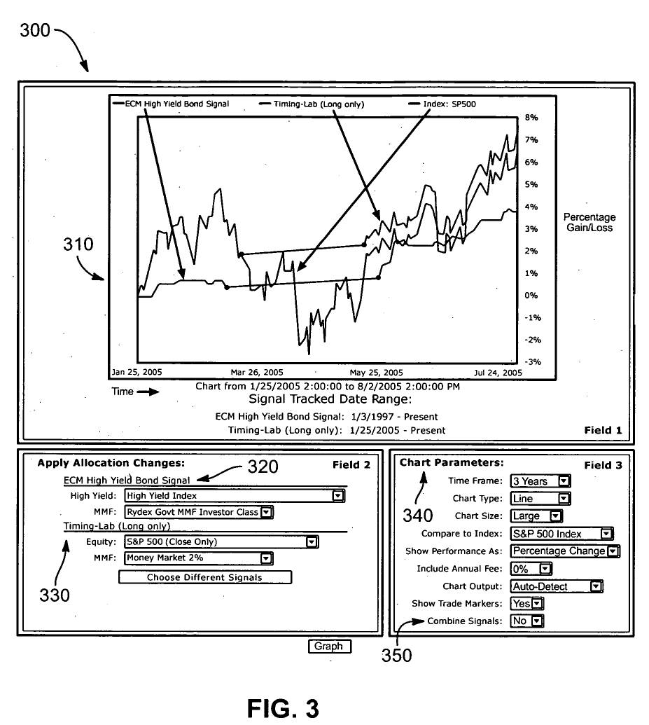

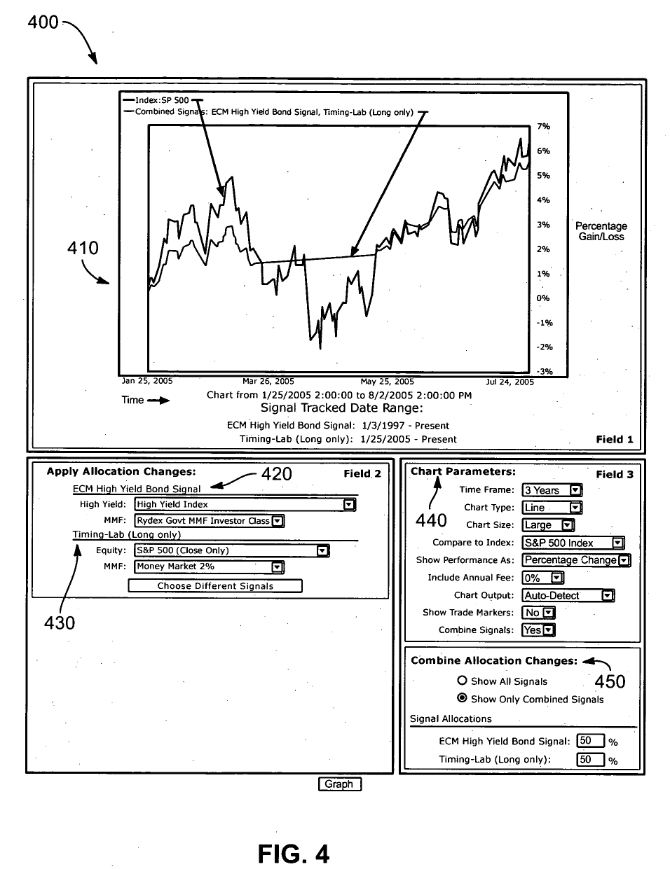

Report module 126 may be operated by microprocessor 114 on server 106 and accessed locally or over a network, such as the Internet or the world wide web. Report module 126's main purpose is to generate and update medallion reports 124 and other reports related to prognosticator 102 performance and information. Report module 126 provides a user-friendly graphical user interface (GUI), such as seen in FIGS. 3 and 4, that may include pull-down menus and click-through navigation to create medallion report 124.

Server 106 operates to provide third party verification of performance through recordation of time-date stamps 118 of allocation changes 104 sent by prognosticators 102 in real-time. A medallion report 124 will not reflect any past purported performance, only prognosticator timing information that is verifiable by server 106. Thus, a medallion report 124 illustrates only the real-time performance of allocation changes 104 for a time period verified by the server 106.

A subscriber 122 or prospective subscriber may, from a subscriber computer terminal 132 employing a conventional Internet web browser 134, access a prognosticator's web page 136. Prognosticator 102 accesses a prognosticator medallion creation page 130 to create a medallion link 138, which is customized to prognosticator 102's signal asset classes and located on the prognosticator 102's web page 136. Subscriber 122 may click on medallion link 138, which causes Internet browser 134 to open a report web page 140 hosted by server 106. Web page 140 then will display medallion report 124 after communicating with server 106 for reception of medallion report 124.

That communication occurs after subscriber 122 initiates report module 126. Then, server 106 may access database 120 to update and fill medallion report 124 and send it to subscriber 122 for viewing within web page 116. Medallion report 124 displays the performance of the underlying strategy or prognostication as well as actual or hypothetical performance including the effect of hypothetical fees and expenses on allocation change signal performance. Medallion report 124 may provide a subscriber with additional information about the value of allocation changes with the prognosticated assets compared to an index.

Report module 126 may generate a URL 128 such as http://www.prognosticator.com/report, or other form of address, which is associated with a medallion report 124 and hosted by server 106. Prognosticator 102 may display URL 128 on web page 136, in an e-mail, or in other electronic documents (not shown), such as newsletters or direct electronic transfers. Medallion link 138 may be a graphical icon that is associated with a medallion report 124. Graphical icons include logos, animated graphics, stylized text, and the like. These graphical icons may also be linked to URL 128 and displayed in electronic documents, including e-mail and literature, such as newsletters. Both URL 128 and medallion link 138 associated with URL 128 may be referred to generally as “medallions” because they provide electronic acknowledgement of performance when requested by subscriber 122.

In an alternative embodiment, an award medallion 142 may also be posted on prognosticators' or on money managers' websites 136 indicating a performance award, which is further electronic acknowledgement of performance. An award medallion 142 may link to both static and dynamic performance awards. Static awards are posted immediately and are dispensed by server 106 when prognosticator 102 earns awards over fixed periods such as calendar years or quarters. Dynamic awards only show when server 106, or a host who operates the server, determines that they are earned and may be removed when merited. An award medallion 142 may link to server 106 where a performance web page 144 may be generated that explains the performance award.

In further alternative embodiments, award medallions 142 may also be attached to an e-mail or other electronic literature. A performance award may further include a unique URL which may be printed in literature. Subscribers may search for performance awards and use a performance award as a criterion for subscription.

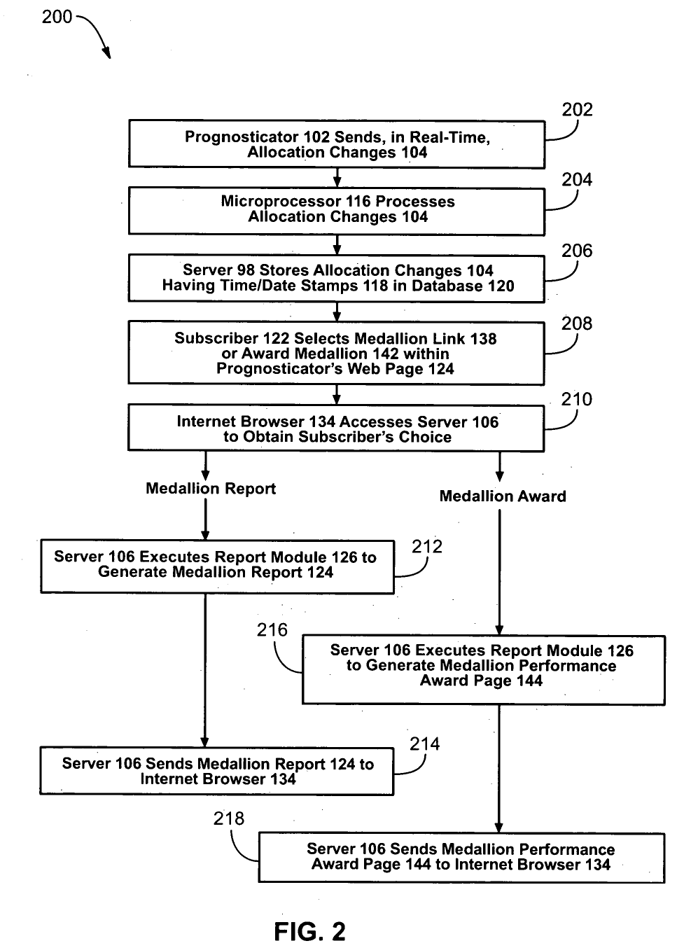

Referring to FIG. 2, a flow diagram 200 of one embodiment of the disclosed method is displayed. A prognosticator 102 sends 202 allocation changes 104 from an information submissions page 108, or alternatively, via e-mail or another method. Allocation changes 104 pass through a network and/or the Internet and arrive at server 106. Microprocessor 114 then processes 204 allocation changes 104 by attaching time-date stamps 118 for later verification through authentication. Server 106 then stores 206 allocation changes 104 along with associated time-date stamps 118 in database 120.

Subscriber 122 may then select 208 medallion link 138 or a medallion award 142 within prognosticator 102's web page 136. Internet browser 134 accesses 210 server 106 to obtain the data associated with subscriber 122's choice. If a medallion report 124 is requested, server 106 executes 212 report module 126 to generate it, using a plurality of parameters chosen by subscriber 122. Allocation changes 104 on database 120 are accessed and microprocessor 114 again verifies that time-date stamps 118 are authentic as medallion report 124 is assembled.

A URL 128 may be associated with medallion report 124 so access to the medallion report 124 may be directly through prognosticator 102's web page 124, or linked to through e-mail or another means. If the former, server 106 finally sends 214 medallion report 124 to Internet browser 134 for viewing by subscriber 122 in a medallion report page 140. As discussed, medallion report 124 includes a GUI within report page 140 and so subscriber 122 may change parameters to modify medallion report 124 or test alternate equities, asset classes, or indexes.

If subscriber 122 instead chooses a medallion award 142, server 106 executes 216 report module 126 or an affiliated report module with microprocessor 114, accessing database 120 for the required data. This data may include information regarding prognosticator 102 as criteria required for a performance award. To ensure grant of a performance award is merited, report module 126 also verifies allocation change 104 performance through authentication of time-date stamps 118. The sum total of prognosticator 102 meeting a plurality of criteria and server 106's authentication of the award is sent 218 to subscriber 122 in the form of a performance award page 144 for viewing in Internet browser 134. If a performance award is no longer merited, server 106 may statically or dynamically ensure that medallion award 142 is removed from web page 136.

Referring to FIG. 3, one embodiment of a graphical representation 300 of a medallion report 124 is shown. A medallion report 124 may include a graphical display 310 of performance with comparative index illustrations including hypothetical fee and expenses, time periods, asset classes, and other pertinent details. Signal asset classes 320 and 330 are referred to as “classes” because each allocation change 104 (or graph displayed on chart 310) moves between a plurality of equities and assets according to prognosticator 102's recommendations. For instance, asset class 320 moves between a High Yield Index and the Rydex Government Money Market Fund Investor Class.

As illustrated, the medallion report 124 provides a GUI inside of medallion report page 140 to allow subscriber 122 to modify parameters 320-340 in Fields 2 and 3, as desired, to modify the generated medallion report 124. A similar GUI having the same or similar parameters 320-340 is also provided by report module 126 for initial creation of medallion report 124. Prognosticator signal asset classes 320-330 and chart parameters 340 may be selected and modified through these GUIs. A plurality of signal asset classes may be chosen; therefore, just because FIGS. 3 and 4 use two sets of asset classes does not mean there cannot be more.

As shown in medallion report 300, chart 310 shows signal asset classes 320 and 330 and a comparative index, such as the S&P 500 or the NASDAQ 100. The vertical axis displays the three signals' “Percentage Change” while the horizontal axis tracks over the “Time Frame” chosen. Both of these are modifiable in Chart Parameters 340 of Field 3. Performance along the vertical axis may also be displayed as growth of $10,000, or another set sum, over the time period chosen. Note also that signal asset class 330 does not have signal data all the way back to the start of the “Time Frame,” indicating that server 106 had not received allocation changes 104 until the start point of signal asset class 330. This is demonstrative that medallion reports 124 will only comprise authenticated allocation changes 104, using time-date stamps 118.

Parameters 340 that subscriber 122 may modify include Time Frame, Chart Type, Chart Size, Compare to Index, Show Performance As, Include Annual Fee, Chart Output, and Show Trade Markers. Subscriber 122 may also choose to Combine Signals 350 of more than one asset class 320 and 330 of Field 2, which if done with asset classes of FIG. 3, results in chart 410 shown in FIG. 4. Thus, subscriber 122 is not restricted to only the default view created by prognosticator 102 in medallion creation page 108.

Subscriber 122 may, by way of example, extend or shorten a time period by changing “Time Frame” in parameters 340. A subscriber 122 may also choose to display Trade Markers of parameters 340, which are points in time when prognosticator 102 sent a buy or sell allocation change 104 signal to server 106. A subscriber 122 may also compare prognosticator signal asset classes 320 and 330 with another index through changing the “Compare to Index” parameter 340, which is also displayed on chart 310. Thus, an initial view of medallion report 124 may be set by prognosticator 102, but subscriber 122 may modify views to perform additional research.

A prognosticator 102 may also modify an existing medallion report 124 as desired to reflect assets prognosticated, time periods, comparative index, graph size, and other items through medallion creation page 130. Prognosticator 102 makes such updates through the medallion creation page 130. This creates a new default for subscribers 122 to choose, but parameters 340 remain modifiable by subscriber 122 as discussed above.

As seen in FIG. 4, display 400, and specifically chart 410, when subscriber 122 chooses to combine signals of more than one asset in parameters 440 “Combine Signals,” two signals are added together to generate one composite, combined signal. This combined signal may be generated giving equal allocation to each signal, as shown in FIG. 4 of those signals displayed in FIG. 3, or a greater weight can be given to one as compared to another by changing “Combine Allocation Changes” parameters 450. The combined signal may continue to be compared to market index S&P 500, thus allowing keener insight into a prognosticator's performance over multiple assets over time.

As with FIG. 3, display 400 of FIG. 4 also allows modification of medallion report 124 through changing parameters 440 of Field 3 or even choosing to combine one or more different signal asset classes 420 and 430 of Field 2. Such changes, once re-graphed, will immediately be reflected in a modified chart 410, thus facilitating real-time updates in a subscriber's research.

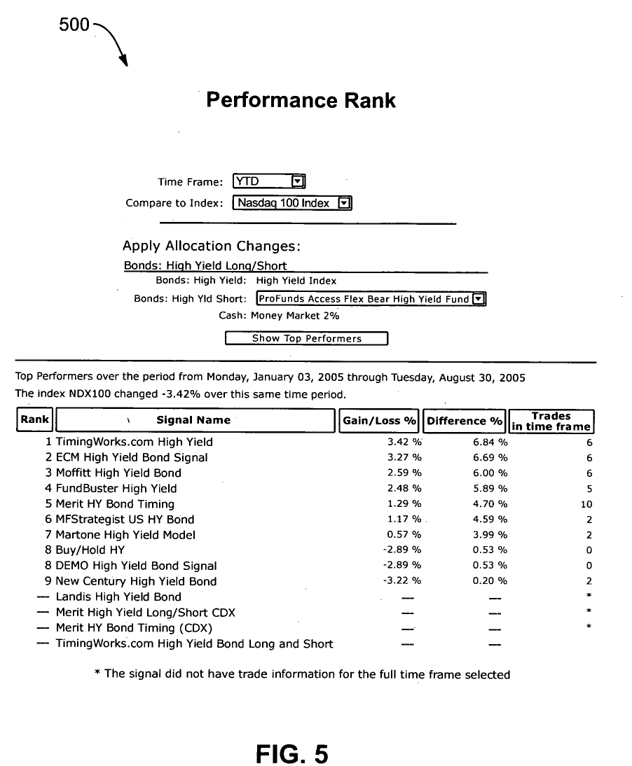

Now referring to FIG. 5, a subscriber 122 accessing server 106 may also modify reports to rank a plurality of prognosticators 102 according to performance for various time periods and various asset classes. As in graphical representations 300 and 400 of FIGS. 3 and 4, a Performance Rank Report 500 uses a “Time Frame” and a “Compare to Index” along with a signal asset class with which prognosticators 102 are being compared. Following the columns from left to right the ranking chart may include: rank, signal name, a gain/loss percentage of that signal, a difference percentage of the signal when compared with the comparative index's gain/loss over the same time frame, and the number of trade “Allocation Change” 104 signals sent in the time frame. This is yet another way the system and method disclosed herein allows subscribers an easy and effective manner of using tracking signal data to make investment decisions. A medallion report 124 may also show prognostication decision points and allocations through subscriber 122 choosing “Show Trade Markers” in parameters 340.

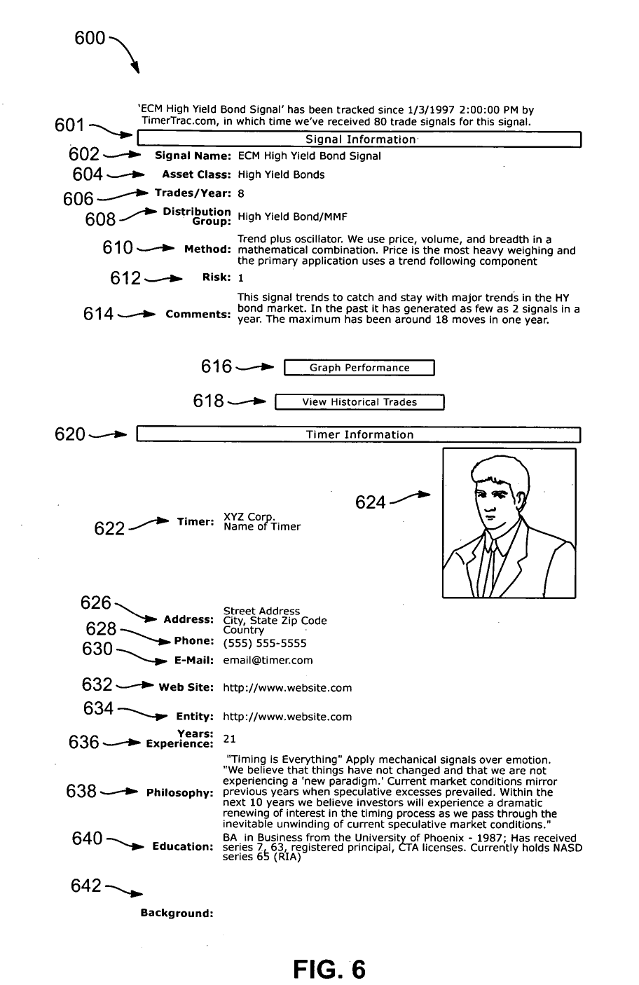

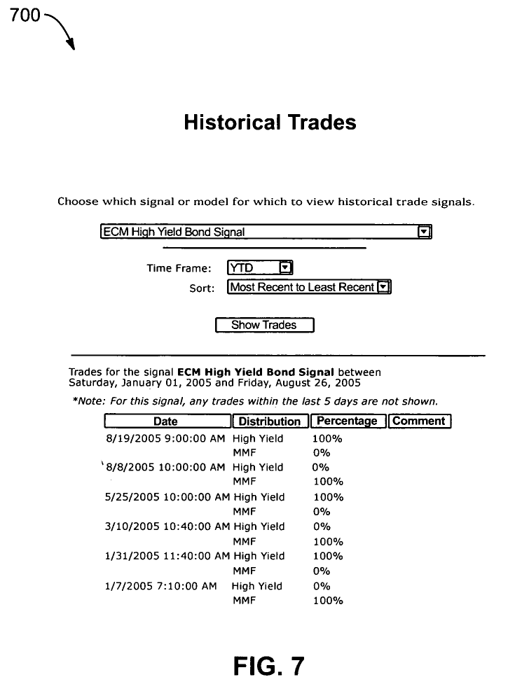

As seen in FIG. 6, a medallion report 124 may also provide details of various prognosticators. Such reports may be accessed through clicking on the “Show Top Performers” link found in FIG. 5's prognosticator ranking, as well as in other locations on web page 136 hosted by server 106. Information in a prognosticator report 600 such as shown in FIG. 6 may be grouped between signal information 601 and timer (or prognosticator) information 620. Signal information 601 may include, but is not limited to: Signal Name 602, Asset Class 604, Trades/Year 606, Distribution Group 608, Method of signal determination 610, Risk level 612, and Comments 614. Likewise, linking through the “Graph Performance” button 616 within signal information 601 will generate a graph such as seen in FIG. 3. Linking through the “View Historical Trades” button 618 will generate a report as displayed in FIG. 7, which is discussed below.

Timer information 620 is further displayed in FIG. 6, which may include, but is not limited to: Timer (or prognosticator) name 622, Picture 624, Address 626, Phone 628, E-mail 630, Web Site address 632, Entity type 634, Years of Experience 636, Philosophy regarding timing trades 638, Education 640, and Background 642 of the timer. The report shown in FIG. 6 and the reports a subscriber 122 can link to through it provide subscribers abundant information regarding a timer's track record, background, and philosophy, thus aiding in the decision of which prognosticator(s) 102 a subscriber 122 wants to track for making trading decisions.

Now referring to FIG. 7, historical trade information of a prognosticator 102 may be displayed for a specific signal asset class, such as 320 or 330 of FIG. 3. This information may be accessed by linking through button 618 displayed in FIG. 6, or from a menu on web page 136 hosted by server 106. As shown in FIG. 7, the signal asset class, the Time Frame requested, and the Sorting mechanism may be modified through the report's GUI. Sorting the historical trades may be from “Most Recent to Least Recent,” or vice versa. If subscriber 122 modifies these parameters and clicks “Show Trades,” then a modified historical trade chart is displayed.

FIG. 7, as an exemplary historical trade report 700, shows that the ECM High Yield Bond Signal recommends buying or selling between a money market fund or a particular equity, here “High Yield Bond,” at the date-time of the allocation change 104 signal sent to server 106. These points in time are also used as “Trade Markers,” shown in FIGS. 3 and 4 on charts 310 and 410. The date and time of the recommendation is shown in the first column, followed by the distribution of the recommendation (if any) between the assets in the signal class in the next two columns. As shown, the recommendation was always a pure buy or sell allocation change signal in this case. The last column is available for comments regarding the recommendation.

The present disclosure provides verification to subscribers to a prognosticator's website that the received data in a medallion report 124 is accurate. Accessing verification is effective, reliable, and generated report views may be modified. In this manner, tracked market prognosticators are able to “broadcast” market data to subscribers and potential subscribers. Prognosticators may send projections to a daily digest that is accumulated and forwarded to subscribers wishing to be on the broadcast list. The broadcast is optional for both prognosticators as well as subscribers.

A medallion report 124 may include additional features to track the performance of money managers or investment advisors. These measures are common to the financial industry and include the ulcer index, max drawdown, volatility rankings, etc. These measures may be computed and used in reports and provide subscribers with additional search/sort capabilities essential to making investment decisions.

A medallion report 124 may also use similar functionality to track money managers who use specific accounts for tracking or other methods of tracking. Functionality for tracking continues to use all the verification features mentioned above. Money manager tracking may utilize an additional URL for tracking.

Subscribers 122 have the ability to generate personalized reports and store their own prognosticator/money manger choices for evaluation and review and updating. Subscribers may use combinations of data according to their own custom and unique weightings. Subscribers have the ability to search and sort reports based on performance measures, frequency measures, awards measures, time tracked measures, or other measures.

Medallion reports may be generated for single prognosticators and managers as well as portfolios of the same. Subscribers may combine prognostications and other performance into useable data. Combining strategies and prognostications into single views is important to investment decisions and allows subscribers to develop hypothetical portfolios based on the use of multiple prognosticators or money managers. In addition, combined strategies have separate and distinct statistical findings.

It will be readily apparent to those having skill in the art that many changes may be made to the details of the above-described embodiments without departing from the underlying principles and scope of the disclosure. Various modifications and variations apparent to those of skill in the art may be made in the arrangement, operation, and details of the methods and systems of the described embodiments. Therefore, the scope of the embodiments of the disclosure should be determined only by the following claims.

1. A system for prognosticator performance verification, comprising:
a server having a memory with a report module resident thereon, the server to receive allocation change signals from a plurality of prognosticators and to attach time-date stamps to the allocation changes, wherein the server also sends a medallion performance report in response to a subscriber's request; and
a database in electronic communication with the server for storing the allocation changes and supplying the allocation changes to the report module with which the report module, when initiated, generates the medallion report.

2. The system of claim 1, wherein the medallion report includes a plurality of chart parameters, defaults for which are set by at least one prognosticator, and reports on a plurality of signal asset classes.

3. The system of claim 2, wherein the system further comprises a medallion link residing on a prognosticator's web page for initiation of the report module by a subscriber.

4. The system of claim 3, wherein the medallion link comprises a URL address to the server memory.

5. The system of claim 4, wherein the medallion link is displayed as a graphical icon.

6. The system of claim 4, wherein the medallion report comprises:
an illustration of the real-time performance of a prognosticator's allocation changes for a specified time period;
a graphical user interface for selection and modification of the parameters that interest a subscriber; and
indication of verification of the server that the allocation changes' time-date stamps were authentic, real-time signals when received by the server.

7. The system of claim 6, wherein the medallion report comprises a graphical representation of ranking prognosticators' performance in allocation changes for a given asset and time period.

8. The system of claim 7, wherein the medallion report comprises a prognosticator report containing a plurality of parameters, the parameters including detailed performance information about a subscriber-selected signal asset class and the prognosticator affiliated with the signal asset class.

9. The system of claim 8, wherein a further report is linked to containing a graphical representation of historical trade signals for the signal asset class and comprising a plurality of parameters.

10. A method for providing prognosticator performance verification to a subscriber using a server, comprising:
the server receiving allocation change signals from a plurality of prognosticators, each allocation change associated with an asset class;
processing the allocation changes by attaching a time-date stamp on each and storing the allocation changes in a database in electronic communication with the server;
executing a report module resident in the memory of the server when initiated by the subscriber, the report module accessing the allocation changes in the database to create a allocation change performance report; and
sending the performance report to the subscriber.

11. The method of claim 10, wherein the report module, with the allocation changes, generates the performance report for a plurality of signal asset classes using a plurality of chart display parameters, defaults for the parameters having been selected by at least one prognosticator.

12. The method of claim 11, further comprising the report module verifying the authenticity of the allocation changes with the attached time-date stamps before using the allocation changes to generate the performance report.

13. The method of claim 12, wherein initiation of the report module is by the subscriber selecting a medallion resident on a prognosticator's web page and the web page communicating with the server over the world wide web.

14. The method of claim 13, further comprising the subscriber receiving the performance report through the web page.

15. The method of claim 14, wherein the web page communicates with the server over a local area network.

16. The method of claim 11, wherein default chart display parameters are provided by the at least one prognosticator through using a medallion creation web page hosted by the server.

17. The method of claim 15, wherein the medallion comprises a URL address to the server memory.

18. The method of claim 14, further comprising the subscriber modifying the plurality of chart parameters on the received performance report, and displaying in the web page an updated performance report based on the modifications.

19. The method of claim 10, further comprising providing the subscriber the option of generating an additional report containing information relating to at least one prognosticator and the prognosticator's signal asset classes.

20. The method of claim 13, wherein the medallion is an award icon, which when selected, causes the report module to generate an award performance web page for viewing by the subscriber, the award performance web page including performance award explanations.

21. The method of claim 18, wherein modifying includes choosing to chart parameters that will generate a hypothetical performance report based on the allocation changes.

22. A computer readable medium having stored thereon computer executable instructions for performing a method for providing prognosticator performance verification to a subscriber, comprising:
receiving allocation change signals from a plurality of corresponding prognosticators;
storing the received allocation changes in a computer readable medium database;
receiving a subscriber request for a performance medallion report;
actuating a report module in response to the request, the report module stored in the computer readable memory;
accessing the stored allocation changes when the report module is actuated;
verifying that the allocation change signals had been sent in real-time; and
generating a medallion report comprising a plurality of data parameters related to the received allocation changes and an indication that the allocation changes were verified.

23. The computer readable medium of claim 22, wherein the method further comprises:
displaying the medallion report in a subscriber's web page; and
enabling a subscriber to modify the plurality of data parameters to generate and display a modified medallion report based on the modifications.

24. The computer readable medium of claim 23, wherein displaying the medallion report is in a subscriber's e-mail or newsletter.

25. The computer readable medium of claim 23, wherein displaying the medallion report is on the subscriber's computer after executing a downloaded document generated by the computer readable medium.

26. The computer readable medium of claim 23, wherein the method further comprises:
providing subscribers the option of storing their own personalized performance reports; and
combining data from the reports according to a subscriber's unique weightings in a single graph as a tool for analyzing investment decisions.
